(19) United States
(12) Patent Application Publication
(10) Pub. No.: US 2011/0193464 A1
(43) Pub. Date: Aug. 11, 2011

(54) ELECTRIC LAMP

(75) Inventors: Wiktor Plawski, Zdunska Wola (PL); Andrzej Grajda, Pabianice (PL)

(73) Assignee: KONINKLIJKE PHILIPS ELECTRONICS N.V., EINDHOVEN (NL)

(21) Appl. No.: 12/674,177

(22) PCT Filed: Aug. 25, 2008
(86) PCT No.: PCT/IB08/53400

§ 371 Date: Feb. 19, 2010

(30) Foreign Application Priority Data
Aug. 27, 2007 (EP) 07115013.0

(51) Int. Cl. H01J 61/52

(52) U.S. Cl. 313/47

(57) ABSTRACT

An electric lamp having a lamp vessel and a base part. The base part has a mounting cavity. A partition member is provided between the cavity and an opening of the lamp vessel. The partition member has a thermal barrier coating which effectively isolates the heat-generating parts in the lamp vessel from the heat-sensitive parts in the base part.

### FIELD OF THE INVENTION

The invention relates to an electric lamp. More specifically, the invention relates to a lamp comprising a light emitting element in a lamp vessel and a base part with a mounting cavity.

### BACKGROUND OF THE INVENTION

The lamp can be any type of lamp, for instance an incandescent lamp, such as a halogen incandescent lamp, low pressure sodium lighting, an LED, a high intensity discharge lamp, a reflector lamp or the like. Depending on their light efficiency, light emitting elements of lamps tend to generate a lot of heat, which has a serious impact on the lifetime and safety of the lamps and on the cost of their components. Moreover, heat generation limits the possibilities of miniaturization of lamps.

U.S. Pat. No. 5,458,505 shows a lamp with a cooling system. In one embodiment, there is provided a housing with a standard threaded plug for engagement in a standard socket. A printed wiring board comprises circuitry to operate a halogen lamp. The halogen lamp is provided on a heat sink, and a lamp cover is provided around it. The heat sink has holes, and further holes are provided in the lower part of the housing. A fan is arranged to drive air over the electronics. The air enters through openings along the circumference of the base and is exhausted though further openings in a lower part of the base.

It is an object of the invention to provide a lamp with improved heat management, allowing a compact and less heat sensitive design, extending the possibilities of miniaturization.

### BRIEF DESCRIPTION OF THE INVENTION

The object of the invention is achieved with a lamp comprising:

at least one light emitting element;

a lamp vessel enveloping the light emitting element, the vessel having an edge defining a central opening;

a base part with a mounting cavity adjacent the lamp vessel's central opening;

a connection region on the base part for arranging the lamp in a lamp fitting, the connection region being provided with mutually isolated electric contacts for electric current supply to the electric circuit;

electric leads operatively contacting respective contact points of the light emitting element with the electric contacts of the connection region;

a partition member arranged between the mounting cavity and the lamp vessel's opening, the partition member comprising at least one layer of a thermal barrier coating.

The thermal barrier coating effectively isolates the heat generating parts in the vessel from the heat sensitive parts in the base part. This results in a lamp construction with optimized heat management, leading the heat flow away from the more heat sensitive lamp parts. By isolation of certain lamp parts the heat flow within the lamp can be influenced and heat can be dissipated within lamp zones where heat does not disturb the lifetime of the light source or the electronics. Consequently, the heat sensitive parts can be made of cheaper materials, in particular plastics, without affecting the durability of the lamp. This also creates further possibilities of miniaturization. The lifetime of the lamp can be considerably enhanced.

The thermal barrier coating can be applied on the surface facing the vessel or it can be applied on the surface facing the mounting cavity. Optionally, it can be applied on both sides of the partition member.

Electric leads contact the respective contact points of the light emitting element with the electric contacts of the connection region, either directly or via electric parts or an electronic circuit for operating the light emitting element present in the mounting cavity. Such an electronic circuit may be of any type, including electronic circuits that are not associated with burner operation. It can be suited for operating the burner, i.e. supply electrical energy to the burner in a controlled manner. This may comprise switching the burner on or off as well as dimming the burner. The receiver can be suited to receive power line commands over the electrical connection. The electronic circuit may further comprise a control circuit for operating the burner according to the control commands, e.g. switching the burner on/off or dimming it accordingly.

Optionally, the partition member comprises a first shell member and a second shell member, one or both of the shell members being provided with the thermal barrier coating. The first shell member can be arranged to seal the mounting cavity, whereas the second shell member can be arranged to mechanically hold the light emitting element. The shell members can be arranged on top of each other with a separation space between the members. At least one of the shell members provided may be cup-shaped to maintain this separation space. The separation space may be sealed, so that it acts as a blind air chamber. Alternatively, the separation space may also be part of the ventilation path. Thus, heat conduction is effectively limited.

Optionally, ventilation openings are arranged to ventilate air to and from the vessel. The ventilation openings can for example be exclusively arranged in a circle along the circumference of the base. Such a circle can, e.g., be arranged in the region where the cover is mounted to the base. The ventilation openings further serve to limit the effective cross-section of the base in this transition area between the hot vessel section and the cooler section of the mounting cavity.

The base and the vessel can be arranged so that there is no straight path from the ventilation openings to the inside of the vessel. Within the vessel, the light emitting element is arranged with its electrical contacts. By providing a labyrinth structure (no straight path), possible hazards are avoided which may occur if a conducting element, e.g. a wire is inserted into the openings. Most preferably, the path from the ventilation openings to the inside of a cover includes at least one turn of at least 90°. This helps to effectively prevent the hazard described above.

The light emitting element, e.g. a halogen burner, can comprise a burner vessel with protruding contact rods. The element can be mounted by mechanically fixing the contact rods at the partition member, e.g. by molding in the contact rods. Further, electrical leads can be provided, which are connected between the contact rods and an electronic circuit. The electrical leads have a smaller cross section than the contacts rods. This is based on the finding that in heat distribution from the light emitting element to the electronics, the contact rods may play an important part. Usually, these contact rods are provided much thicker than necessary for the pure electrical connection, due to the fact that they also serve as a mechanical connection. If the contact rods are extended up to the electronic circuit, a large amount of heat may be conducted by them. However, if mechanical fixing is already achieved at the partition member, the thinner electrical leads may provide electrical contact between the electronic circuit and the rods, thus limiting the heat transfer.

Thermal barrier coatings are ceramic coatings, typically used with gas turbine technology. The coatings can for example be based on mullite, alumina or zirconia. Zirconia is generally modified with a stabilizer to prevent the formation of the monoclinic phase. Typical stabilizers include yttria, calcia, ceria, and magnesia. Yttria-stabilized zirconia is most commonly used and exhibits resistance to thermal shock and thermal fatigue up to 1150° C. The yttria content is generally about 7-8 wt. %. Calcia-stabilized zirconia typically comprises about 5 wt. % of calcia whereas magnesia-stabilized zirconia generally comprises about 24 wt. % of magnesia.

Optionally, the thermal barrier coatings can comprise dopant oxides, such as for instance scandia oxide and/or ytterbium oxide in combination with, e.g., neodymium oxide and/or gadolinium oxide, as proposed in U.S. Pat. No. 7,186,466.

Other suitable thermal barrier coatings are for instance the lanthanide sesquioxide-based compositions disclosed in U.S. Pat. No. 7,226,672. A thermal barrier coating which exhibits particularly low thermal conductivity can for example comprise at least 15 mol % of at least one lanthanide sesquioxide, and the balance comprising a first oxide selected from the group consisting of zirconia, ceria, and hafnia. The first oxide can, e.g., be present in an amount greater than 50 mol %. Each lanthanide sesquioxide can have a formula A₂O₃ where A is selected from the group of La, Pr, Nd, Sm, Eu, Tb, or mixtures thereof.

A further suitable thermal barrier coating can, e.g., be based on La₂Zr₂O₇, having a pyrochlore structure, and/or on perovskite (BaZrO₃) and/or on metal-glass composites.

The thermal barrier coating may be applied directly to a surface of the substrate or may be applied to a bond coat deposited on the substrate. Any suitable technique known in the art may be used to deposit a thermal barrier coating in accordance with one of the embodiments of the present invention. Suitable techniques include electron beam physical vapor deposition (EBPVD), chemical vapor deposition, liquid precursor sprayed (LPPS) techniques, diffusion processes, thermal spraying (e.g., air plasma, high velocity oxygen fuel (HVOF)), sputtering, combinations comprising at least one of the foregoing processes, and the like. Whereas for instance EBPVD typically results in a columnar grain boundary, powder thermal sprayed coating typically results in a lamellar structure. Liquid precursor sprayed coatings, on the other hand, typically show a porous structure with vertical cracks and spherical voids.

The bond coat can for example comprise an aluminum containing material, an aluminide, a platinum aluminide, a ceramic material, such as 7 wt % yttria stabilized zirconia, or a MCrAlY material, wherein M is a suitable metal such as nickel and/or cobalt. Other suitable bond coats may be formed from Ta₂O₅, all rare-earth disilicates having the formula X₂Si₂O₇ where X=La, Nd, Pr, Sm, Eu, Gd, Tb, Dy, Ho, Er, Tm, Yb, Lu, or mixtures thereof, Y₂Si₂O₇, mullite, BSAS (barium strontium alumino silicate or celsian), yttrium aluminum garnet, ytterbium aluminum garnet, and other rare-earth aluminate garnets where the rare earth element is selected from the group consisting of Gd, Tb, Dy, Ho, Er, Tm, Lu, or mixtures thereof. Further suitable bond coats can for example be based on NiAl and/or NiCr. Multiple bond coat layers may be multiple distinct layers formed from the same or different materials. Additionally, multiple bond coat layers may be functionally graded layers of mixtures of the above materials. In addition to serving as matching layers and bond coat layers, these layers can act as environment barriers and oxygen barriers.

The bond coat may be formed on the substrate, using any suitable process including, but not limited to, low pressure plasma spraying, electron beam physical vapor deposition, diffusion processes and chemical vapor deposition processes.

A particularly suitable thermal barrier coating system includes one or more layers of a bond coat comprising an oxide-free MCrAlY (M being cobalt and/or nickel) and one or more layers of a top coat of a porous, finely micro-cracked zirconia coating comprising 7-8 wt. % of an yttria stabilizer. With such a top coat composition, a layer thickness of 0.3 mm already yields a temperature difference of up to 200° C.

In a specific embodiment, the partition member can be provided with a recess receiving the edge of the vessel defining its open end, e.g., in a clamping manner or with a snap joint.

The partition member can, e.g., be formed as a disk-shaped part with a diameter smaller than the largest diameter of the vessel. On its side facing the base part, the partition member can be provided with a recess receiving the upper edge of the base part in a clamping manner. One or more snap joints can be used to fixate the partition member to the base part. The partition member can for example be made of a plastic material, such as polybutylene terephthalate (PBTP), polyethylene butylene terephthalate, polyether imide, polyether sulfone, polypropylene oxide, polyphenylene sulfide, polyamide imide or polyimide or any other suitable type of plastic material. Alternatively, the partition member can be made of a glass or ceramic material or a metal such as steel

The base part comprises a connection region for arranging the lamp in a lamp fitting, the connection region being provided with mutually isolated electrical contact points, each of which is connected to one of the current supply conductors. Conventionally, the connection region can be a screw thread suitable to cooperate with a correspondingly screw threaded fitting. Other type of connections can also be used, if so desired.

The base part can, e.g., comprise an outer shell, e.g. of a metal or a plastic material, with a circumferential edge received in a recess in the partition member.

The lamp vessel is typically a bulb of a transparent or translucent material, transmittant for at least part of the light spectrum, such as a glass bulb, e.g., of blown glass protecting the light emitting element from the presence of oxygen. Depending on the type of lamp, the bulb can be evacuated or filled with an inert gas, such as argon, or it can be in open connection with the ambient air, e.g. via the aforementioned ventilation holes. In the case of halogen incandescent lamps, the gas also comprises some gas of one or more halogen elements.

The light emitting element can for example comprise one or more coiled filaments, for instance made of tungsten. Alternatively, the light emitting element can be an incandescent body, e.g., in an inner envelope filled with a halogen-containing gas. In a further alternative embodiment, the light emitting element can be an electrode pair in an ionizable gas, optionally in an inner envelope of, for example, quartz glass.

### BRIEF DESCRIPTION OF THE DRAWINGS

FIG. 1 a side view of a lamp according to a first embodiment of the invention;

FIG. 2 is a sectional side view of the lamp of FIG. 1;

FIG. 3 an exploded side view of the lamp of FIG. 1, FIG. 2;

FIG. 4a is a sectional view of a shell element of the lamp of FIG. 1, taken along the line A . . . A;

FIG. 4b a sectional view of the shell element from FIG. 4a, taken along the line B..B;

FIG. 5 is a perspective, enlarged sectional view of a central portion of the lamp of FIG. 1;

FIG. 6 is a side view of a lamp according to a second embodiment of the invention;

FIG. 7 is a sectional side view of the lamp of FIG. 6;

FIG. 8 is an exploded side view of the lamp of FIG. 6;

FIG. 9 is an enlarged, sectional side view of a top portion of a lamp according to a third embodiment of the invention;

FIG. 10 is an exploded side view of elements of the lamp of FIG. 9;

FIG. 11 is an enlarged, sectional side view of a top portion of a lamp according to a fourth embodiment of the invention;

FIG. 12 is an exploded side view of elements of the lamp of FIG. 11;

FIG. 13 is a side view of a lamp according to a fifth embodiment of the invention;

FIG. 14 is a sectional side view of the lamp of FIG. 13;

FIG. 15 an exploded side view of the lamp of FIG. 13;

FIG. 16 is a perspective, partly sectional view of the lower part of the lamp of FIG. 13;

FIG. 17 is a sectional view of the lamp of FIG. 13, taken along the line C-C;

FIG. 18 is a partly sectional side view of the lamp of FIG. 13, taken along the line D . . . D of FIG. 17.

FIG. 19 is a side view of a lamp according to a sixth embodiment of the invention, with the middle part being shown in cross section.

### DETAILED DESCRIPTION OF THE EMBODIMENTS

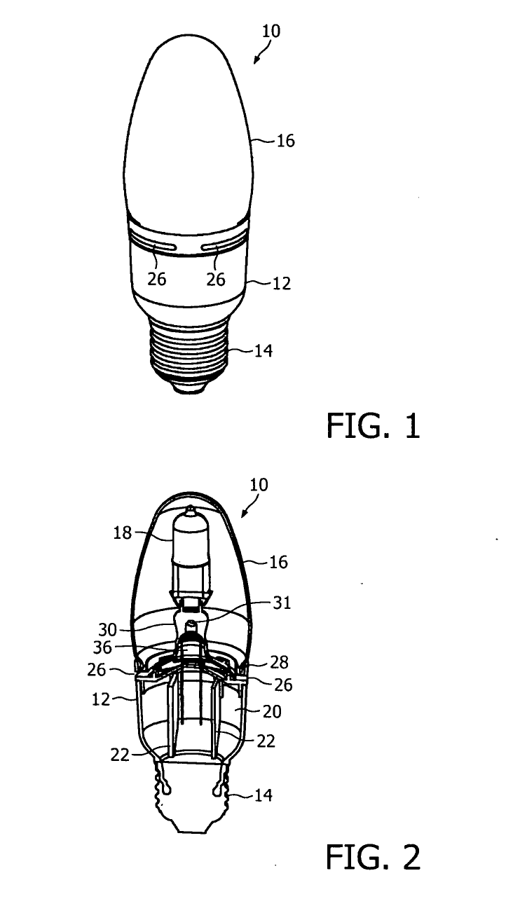

FIG. 1 shows a first embodiment of a lamp 10. The lamp 10 has a base 12 with a screw connection 14. The screw connection for all embodiments will be shown as an E27 screw connection, although the skilled person will appreciate that different connections, e.g. an E14 screw connection, a bayonet connection, or other connections, could also be used.

The lamp 10 further includes a lamp vessel shaped as a glass bulb 16 with an edge 70 defining a central opening. As shown in FIG. 1, the lamp 10 has a light emitting element, being a halogen burner 18, arranged in glass bulb 16. While the bulb type shown has a narrow shape, it will be appreciated that other shapes are possible.

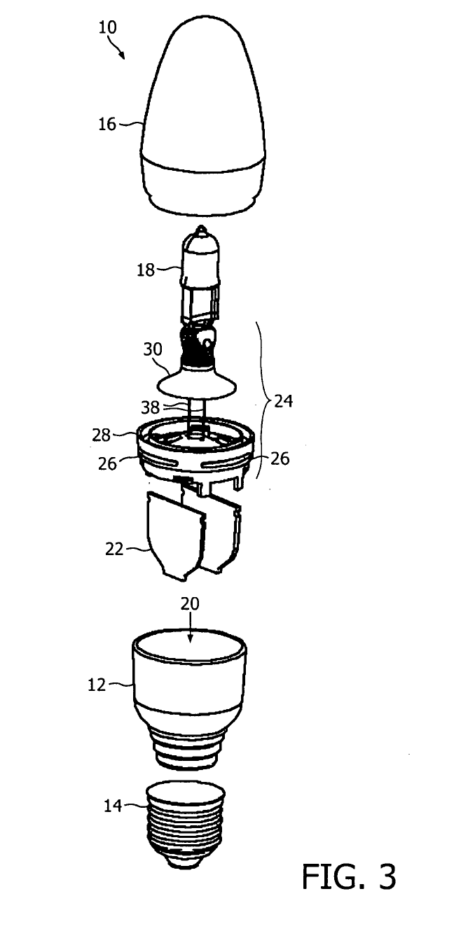

Base 12 is a hollow plastic part with an interior space 20. Within the interior space 20, an electronic circuit is arranged. As is visible in FIG. 3, the electronic circuit comprises two circuit boards 22 arranged vertically in the space 20. The circuit boards 22 are electrically connected to the connector 14 and to the burner 18. The circuits are powered from connector 14. One of the circuit boards 22 is a control circuit which supplies electrical power from the connector 14 to the burner 18 in a switched manner. Thus, the control circuit may turn the burner 18 on or off. By PWM operation, the burner 18 may also be dimmed. The other circuit board 22 comprises a radio receiver to receive control commands. The received commands are passed to the control circuit, so that the burner 18 is operated according to theses commands.

In operation of the lamp 10, the heat generated by the burner 18 needs to be properly dissipated, so that the temperature of the circuits 22 in space 20 of the base 12 does not exceed critical limits. For the purpose of heat management, the lamp 10 is divided into a hot burner zone inside bulb 16 and a cool electronics zone inside base 12.

As will become apparent, measures have been taken to reduce heat conduction between the burner zone and the electronics zone. The burner 18 is arranged high inside bulb 16 to increase the distance. In a central section of the lamp 10, a partition member 24, 24a, 24b is arranged to isolate the zones from one another. Blind air chambers 36 may be provided. Further, the conductors extending from the electronics 22 to the burner 18 have a reduced diameter.

The lamp 10 comprises ventilation openings 26 which are connected to the inside of the bulb 16, so that heat generated by the burner 18 may be dissipated by convection. However, the space 20 inside base 12, where the circuits 22 are mounted, is closed off, so that convection from the hot burner zone cannot introduce heat into the electronics zone.

As is visible from FIG. 3, a partition member 24 is arranged between the base 12 and the bulb 16, and may therefore also be referred to as the interface between these two parts. The partition member 24 comprises a shell ring 28 made of a plastic material coated with a thermal barrier coating, and a glass shell 30 mounted above shell ring 28. The glass shell is cup-shaped. Because of its shape it will be referred to as a glass flare 30.

As is visible from FIG. 3, FIG. 5, the burner 18 comprises a glass burner vessel and protruding legs (contact rods) 32. The contact rods 32, which in the present embodiment are fixed at the burner by clips 34 (see FIG. 5) serve both for mechanical mounting of the burner 18 and electrical connection thereof. The legs 32 are molded into the glass shell 30. Glass shell 30 has the shape of a glass flare with a hollow inside space 36. The legs 32 are securely held in glass flare 30. Electrical leads 38 in glass flare 30 are directly fastened to the legs 32 for electrical connection. Only these electrical leads 38 enter the space 20 of the base 12. As is visible from FIG. 5, the electrical leads 38 have a significantly reduced diameter by comparison to the legs 32. Preferably, the diameter of the electrical leads 38 is less than 50%, most preferably less than 30% of that of the legs 32. In a preferred example, the legs have a diameter of 1.1 mm, and the electrical leads 38 have a diameter of 0.2 mm. The electrical leads 38 extend through the space 36 of the glass flare 30 and also through the shell 28 into the space 20 in base 12, where they are connected to the electronics 22.

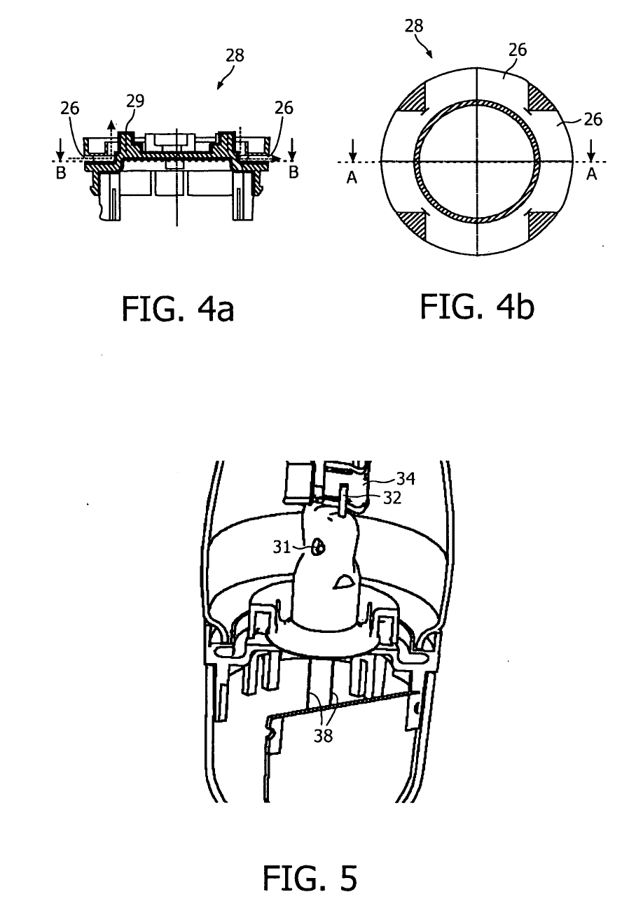

The shell ring 28 is shown in FIGS. 4a, 4b. Shell ring 28 is coated with a layer 29 of a thermal barrier coating at both sides. It has an outer ring which, in the assembled lamp 10, is positioned at the outer periphery of the lamp, in between base 12 and bulb 16. Shell ring 28 is mounted on top of hollow base 12 to seal the base.

On the outer ring, four slots 26 are provided as ventilation openings. The ventilation openings 26 form a circle along the circumference of the lamp 10. As is visible from the arrows shown in FIG. 4a, cool air from the outside may enter through the ventilation openings 26 into the interior of bulb 16. Also, hot air from inside bulb 16 may exit through the ventilation openings 26. If the lamp 10 is mounted in the horizontal direction, this type of convection will occur automatically due to a sort of chimney effect.

The path travelled by the air (shown by dashed arrow lines) going through the ventilation openings 26 is provided such that the path from the ventilation openings 26 to the inside of bulb 16 is not straight. Preferably, the path has in each case a turn of about 90°, which serves to prevent electrical hazards resulting from objects being inserted into the ventilation openings 26.

The partition member 24 is assembled, as shown in FIG. 2, by mounting glass flare 30 on top of shell ring 28. Glass flare 30 may be mounted using different types of connection, including snap-in connections, or with a separate holder element as shown in FIG. 5. Glass flare 30 and shell ring 28 are mounted on top of each other, so that a separation space 36 remains between them.

As will become apparent below, it is possible that the separation space 36 is closed off, so that no convection occurs, and that the chamber, which centrally extends over a significant portion of the cross-section of the interface, serves to isolate the hot burner zone from the cool electronics zone.

However, in an alternative embodiment, the glass flare 30 has a hole 31 in its top portion, which connects the separation space 36 to the inside of the cover 16. By means of heating using the burner 18, a chimney effect may be caused in glass flare 30 to promote the exchange of air through the ventilation openings 26.

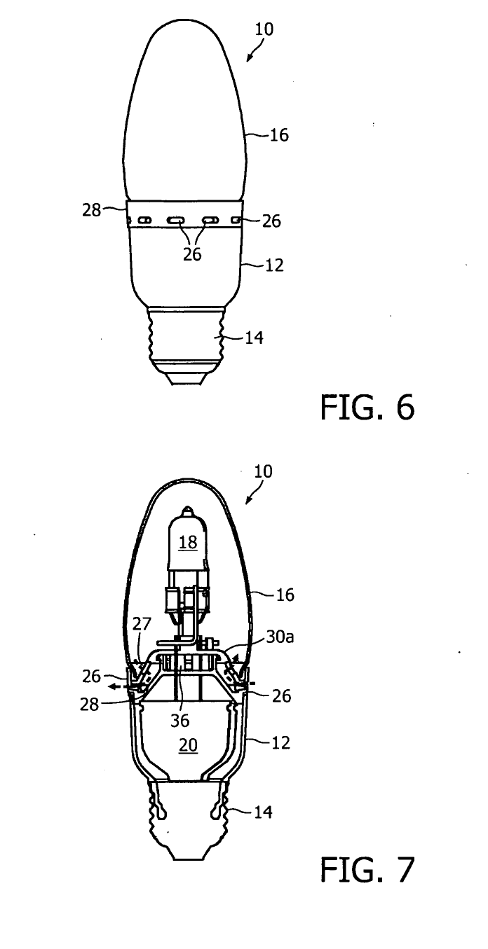

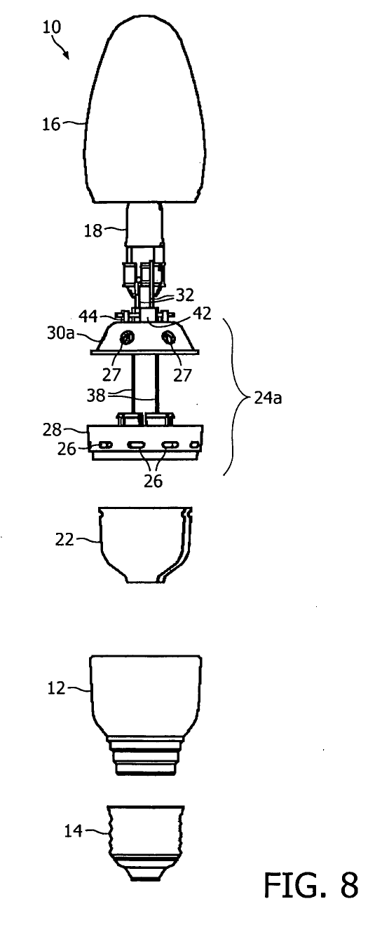

In the following, a second embodiment of the invention will be described with reference to FIG. 6-FIG. 8. As the second embodiment corresponds in large part to the first embodiment, only differences between the embodiments will be explained in detail. Parts common to both embodiments will be referred to by identical reference numerals.

The second embodiment differs from the first embodiment in that the mounting of the burner 18 and the construction of a partition member 24a are different.

In the second embodiment, the partition member 24a also comprises a shell ring 28 whose surface faces the glass bulb 16 coated with a layer 29 of a thermal barrier coating. The shell ring 28 is slightly differently shaped than that of the first embodiment. However, it also comprises an outer ring with ventilation openings 26 provided in a circle along the circumference.

The second part of the partition member 24a is an upper shell 30a made of a plastic material. As shown in FIG. 7, upper shell 30a is arranged on shell ring 28 so that a central blind air chamber 36 remains between the two. As in the first embodiment, here also the partition member 24 is in essence a double-walled partition with excellent insulation properties.

The upper shell 30a is cup-shaped. A plurality of inner ventilation holes 27 are provided in the upper shell 30a. As is visible from FIG. 7, the path travelled by the air (dashed arrows) through the outer ventilation openings 26 includes a first section provided between the shell ring 28 and the upper shell 30a and then extends through the inner ventilation holes 27. The path is not straight, so that any electrical hazards are avoided.

The legs 32 of burner 18 are mechanically fixed to upper shell 30a. The legs 32 are fixed to a holding block 42, which is part of the upper shell 30a. The legs 32 are bent through 90°, their ends further being secured in holding blocks 44. Thus, burner 18 is mechanically fixed to the upper shell 30a. As the upper shell 30a is received in shell ring 28, the burner is fixed to the partition member. Again, electrical leads 38 of significantly reduced diameter lead from the legs 32 to the electronics 22.

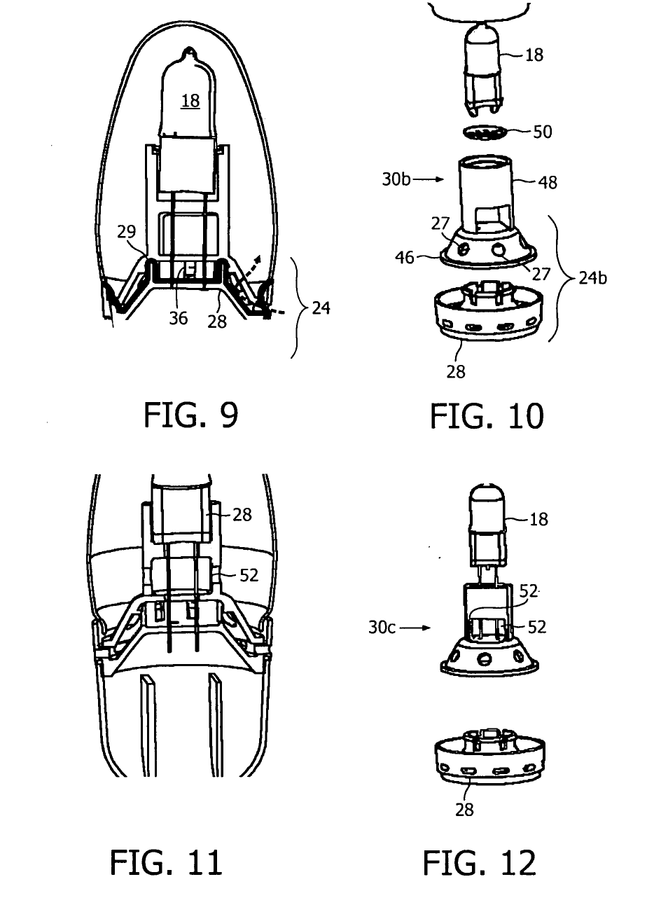

In the following, a third embodiment will be explained with reference to FIG. 9, FIG. 10 and a fourth embodiment will be explained with reference to FIG. 11, FIG. 12. The third and fourth embodiments differ from the second embodiment in the way the burner 18 is mounted on the partition member.

In the third embodiment, the shell ring 28 with the thermal barrier coating 29 is the same as in the second embodiment. The second part of the partition member 24b is provided as a holder 30b, which includes a cup-shaped shell 46 of about the same shape as the corresponding part in the second embodiment. The shell 46 is provided with holes 27 and received in the shell ring 28, so that a double-walled partition member 24 with a blind air chamber 36 and labyrinth air paths is provided.

Holder 30b further comprises a holding part 48 which receives the lower part of burner 18. A metallic spring member 50 is inserted into the holder part 48, so that the burner 18 is clamped and hence mechanically fixed.

The fourth embodiment largely corresponds to the third embodiment. A ceramic holder part 30c holds the burner 18. The burner 18 is glued to the holder part 30c. Alternatively, it may also be fixed by ceramic cement. In this embodiment, the legs of the holder part 30c have holes 52 to weaken the diameter. This serves to reduce heat conduction.

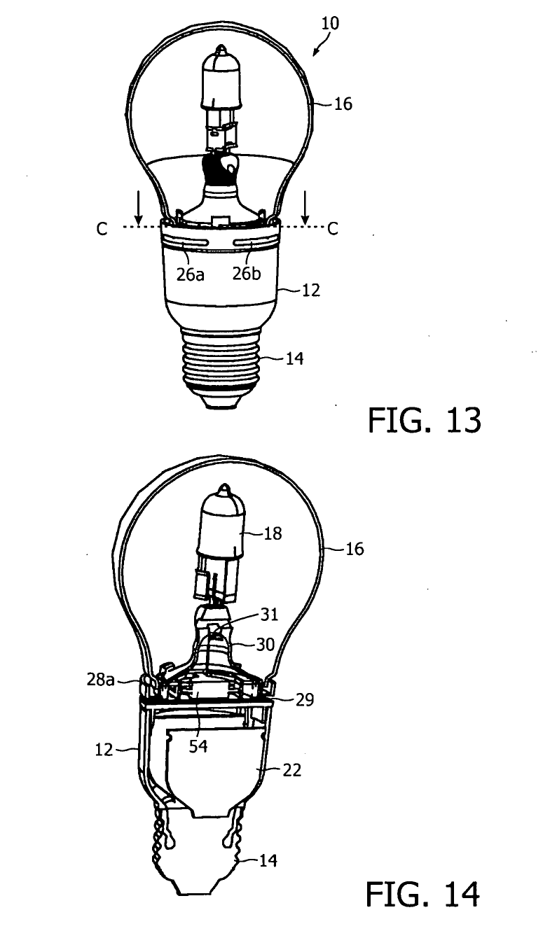

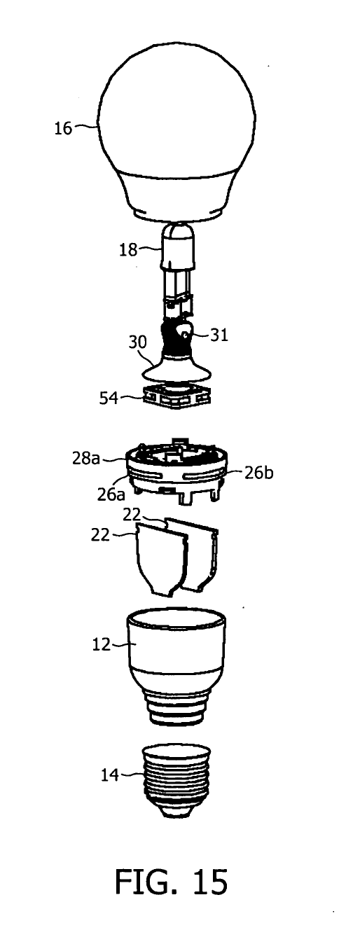

In the following, a fifth embodiment will be explained with reference to FIGS. 13-18. Again, like numerals refer to like parts in all embodiments.

As in the first embodiment described above, the lamp 10 has four slotted ventilation openings arranged in a circle along the circumference of the base 12. However, according to the fifth embodiment, convection cooling of the hot burner zone does not rely on natural convection. Instead, a fan 54 is provided to draw in air from the outside and feed the air to the inside of the bulb 16.

Consequently, the ventilation openings comprise designated inlet openings 26a and outlet openings 26b.

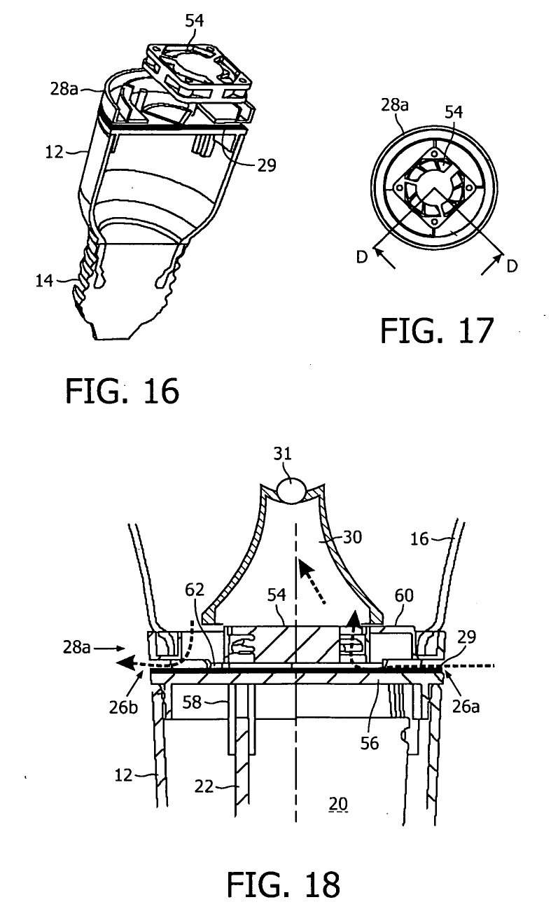

The fan 54 is of the axial type. As shown in FIG. 16, it is mounted in a specially adapted shell ring 29. The fan 54 is mounted coaxially in the lamp 10, so that it transports air in axial direction towards the burner 18.

As shown in FIG. 18, shell ring 28a comprises a plate 56 provided with a layer 29 of a thermal barrier coating and sealing the cavity 20. Protrusions 58 from the plate 56 serve to hold the circuit board 22. The shell ring 28a is divided into four quadrants, corresponding to the four ventilation openings 26a, 26b. Inlet openings 26a and outlet openings 26b are arranged alternately. The split section of FIG. 18 shows to the right an inlet opening 26a. Here, the path from inlet opening 26a to the interior of bulb 16 is blocked by a blocking wall 60, so that air from the outside is only drawn in through fan 54.

To the left, an outlet opening 26b is shown. Here, blocking wall 60 is not present. Instead, a partition wall 62 is provided isolating the fan 54 from the outlet opening 56. Thus, hot air from inside the bulb 16 exits through outlet opening 26b.

As is visible from FIG. 18, the air transported from the fan 54 is directed into the interior of glass flare 30. Glass flare 30 at the top has a ventilation channel 31, which allows the air from the inside to enter the bulb 16. Consequently, this leads to air exiting from the inside of the bulb 16 as explained above.

It will be appreciated by the skilled person that the fan arrangement as shown with regard to the fifth embodiment may alternatively also be included with any other of the embodiments.

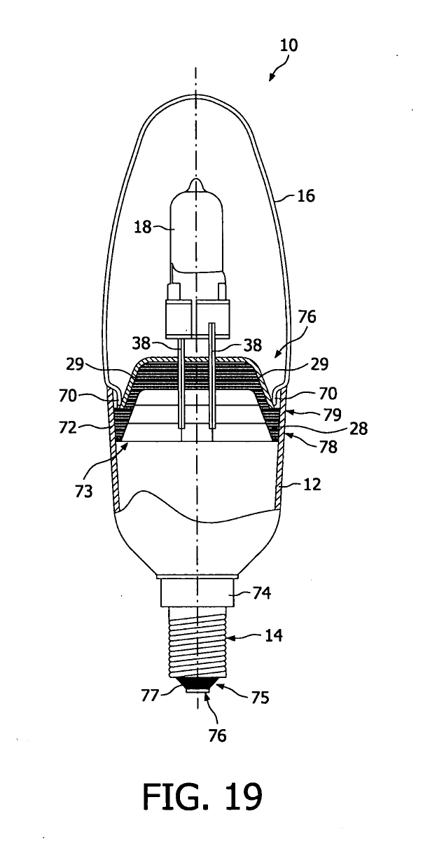

FIG. 19 shows a sixth embodiment. Again, like numerals refer to like parts in all embodiments.

Lamp 10 has a base 12 with a screw connection 14 and a lamp vessel shaped as a glass bulb 16. The glass bulb 16 envelops a light emitting element 2. Two electric leads 38 for the supply of electric current are in contact with the respective electric contact points of the light emitting element 2. The glass bulb 16 has an edge 70 defining a central opening 71. Base part 12 caps the bulb's central opening 71. The base part 12 comprises a thin-walled shell of a plastic material, which is partly broken away in the drawing. The shell of base 12 houses an electric circuit (not shown). At its end facing the bulb 16, the base 12 has a circumferential outer edge 72 defining a central opening 73. The shell of base 12 leads to a cylindrical part 74 leading to a cylindrical connection region 14 of a thin-walled metal undulated so as to form an external screw thread, and an end portion 75 provided with a first electrical contact point 76. In the embodiment shown, the other electrical contact point is formed by the undulated portion of the connector 14, isolated from the first electrical contact point 76 by an isolating region 77.

The base part 12 and the bulb 16 are connected to opposite sides of a partition member 28, shown in cross-section in the drawing. The partition member 28 closes off the bulb's opening 71 on the one hand and the shell's opening 73 on the other. The partition member 28 has openings for the passage of the electric leads 38. On its surface facing the bulb 16, the partition member 28 is provided with a layer 29 of a thermal barrier coating.

On its coated side, the partition member 28 is provided with a recess 78, close to its perimeter, for receiving the edge 70 of the bulb 16 in a clamping manner. On its other side, the partition member 28 shows a recess 79 formed by a staggered outer diameter, to receive the outer edge 72 of the base 12 in a way that the outer surface of base 12 is flush with the outer surface of the partition member 28.

In cross-section, the partition member 28 is U-shaped, with its coated side protruding into the opening 71 of the bulb 16, to enhance the resiliency of the partition member 28.

The bulb 16, the partition member 28, and the base 12, connector 14 and end portion 75 are coaxially arranged rotationally-symmetrical elements.

1. Electric lamp comprising:
at least one light emitting element;
a lamp vessel enveloping the light emitting element (18), the lamp vessel having an edge defining a central opening;
a base part defining a mounting cavity adjacent the lamp vessel's central opening;
a connection region on the base part for arranging the lamp in a lamp fitting, the connection region comprising mutually isolated electric contacts for electric current supply to the electric circuit;
electric leads operatively contacting respective contact points of the light emitting element (18) with the electric contacts of the connection region; and
a partition member arranged between the mounting cavity and the lamp vessel's opening, the partition member comprising at least one layer of a thermal barrier coating.

2. An electric lamp according to claim 1, wherein the partition member defines a recess in which the edge of the vessel defining its open end is received.

3. An electric lamp according to claim 1, wherein the lamp vessel defines a plurality of ventilation openings for facilitating ventilation of the space enclosed by the lamp vessel.

4. An electric lamp according to claim 1, wherein the thermal barrier coating comprises zirconia stabilized with yttria.

5. An electric lamp according to claim 1, wherein the thermal barrier coat is applied on a layer of a bond coat comprising oxide-free MCrAlY, with M being cobalt, nickel or mixtures thereof.

6. (canceled)
